(19) United States
(12) Patent Application Publication
(10) Pub. No.: US 2024/0311741 A1
(43) Pub. Date: Sep. 19, 2024

(54) DIGITAL NOTIFICATION SERVERS, METHODS, AND NON-TRANSITORY COMPUTER-READABLE MEDIA

(71) Applicant: MASTERCARD INTERNATIONAL INCORPORATED, Purchase, NY (US)

(72) Inventors: Alexa Hijazi, Bronxville, NY (US); Prateek Khamesra, White Plains, NY (US); Vishwa Desai, Paramus, NJ (US); Piyush Maurya, Morganville, NJ (US)

(21) Appl. No.: 18/603,730

(22) Filed: Mar. 13, 2024

Related U.S. Application Data
(60) Provisional application No. 63/489,920, filed on Mar. 13, 2023.

(51) Int. Cl. G06Q 10/083

(52) U.S. Cl. CPC G06Q 10/083

(57) ABSTRACT

Digital notification servers, methods, and non-transitory computer-readable media. In one embodiment, a server including a communication interface, a memory, and an electronic processor. The electronic processor is configured to receive supplier information and a plurality of digital notifications from the supplier interface device, each of the plurality of digital notifications linked to one or more remuneration vehicles of a plurality of remuneration vehicles and the supplier information, store the supplier information and the plurality of digital notifications in the memory, receive a request for the plurality of digital notifications from the third-party server, the request including the supplier information, and output the plurality of digital notifications to the third-party server, wherein the plurality of digital notifications notify a user of the third-party server of a difference between the plurality of remuneration vehicles and other remuneration vehicles.

### CROSS-REFERENCE TO RELATED APPLICATION

This application claims priority to, and the benefit of, U.S. Provisional Application No. 63/489,920, filed on Mar. 13, 2023, the entire contents of which is incorporated herein by reference.

### FIELD

The present disclosure relates generally to a digital notification server. More specifically, the present disclosure relates to a digital notification server with a plurality of digital notifications associated with a plurality of remuneration vehicles.

### BACKGROUND

In conventional digital notification systems, a supplier usually leverages a third-party communication agency and/or a communication network to distribute a digital notification to users. For example, the communication agency may place online notifications in third-party webpages or in third-party smartphone applications that are targeted to various users of the third-party webpages or the third-party smartphone applications.

However, in conventional digital notification communication, the supplier cannot communicate a digital notification to targeted users in the third-party webpages or in the third-party smartphone applications regarding specific remuneration vehicles when the targeted users enter a location associated with the supplier and/or are making a decision between different remuneration vehicles to use with the third-party webpages or in the third-party smartphone applications.

### SUMMARY

In an embodiment, a server of the present disclosure solves the problems associated with conventional digital notification communication. A supplier may send a digital notification targeting specific user to a server that relays the digital notification to the targeted users in the third-party webpages or in the third-party smartphone applications regarding specific remuneration vehicles when the targeted users are making a decision between different remuneration vehicles to use with the third-party webpages or in the third-party smartphone applications. A supplier may also send a digital notification targeting specific user to a server that relays the digital notification to the targeted users in the third-party webpages or in the third-party smartphone applications regarding specific remuneration vehicles when the targeted users enter a location associated with a supplier.

For example, in one embodiment as indicated above, the present disclosure includes a server. The server includes a communication interface, a memory, and an electronic processor communicatively connected to the memory. The communication interface is configured to communicate with a supplier interface device, communicate with a vehicle holder interface device, and communicate with a data storage server. The electronic processor is configured to receive transaction information from the data storage server, generate operation recommendations based on the transaction information that is received from the data storage server, generate operation creation and workflow with the enterprise platform and based on the operation recommendations, and generate a graphical user interface for displaying on the supplier interface device, the graphical user interface based on the operation creation and workflow.

For example, in another embodiment as indicated above, the present disclosure includes a method. The method includes controlling, with an electronic processor of a server, a communication interface of the server to receive supplier information and a plurality of digital notifications from a supplier interface device, each of the plurality of digital notifications linked to one or more remuneration vehicles of a plurality of remuneration vehicles and the supplier information. The method includes controlling, with the electronic processor, a memory of the server to store the supplier information and the plurality of digital notifications, the supplier information being associated with the plurality of digital notifications. The method includes controlling, with the electronic processor, the communication interface to receive a request for the plurality of digital notifications from a third-party server, the request including the supplier information and one or more remuneration vehicle identifiers that identify a portion of the plurality of remuneration vehicles. The method includes controlling, with the electronic processor, the memory to retrieve a portion of the plurality of digital notifications from the memory based on the supplier information and the one or more remuneration vehicle identifiers. The method also includes controlling, with the electronic processor, the communication interface to output the portion of the plurality of digital notifications to the third-party server. The portion of the plurality of digital notifications notify a user of the third-party server of a difference between the portion of the plurality of remuneration vehicles and other remuneration vehicles that are distinct from the portion of the plurality of remuneration vehicles.

For example, in yet another embodiment as indicated above, the present disclosure includes a non-transitory computer-readable medium. The non-transitory computer-readable medium comprising instructions that, when executed by an electronic processor, cause the electronic processor to perform a set of operations. The set of operations include controlling a communication interface of a server to receive supplier information and a plurality of digital notifications from a supplier interface device, each of the plurality of digital notifications linked to one or more remuneration vehicles of a plurality of remuneration vehicles and the supplier information. The set of operations include controlling a memory of the server to store the supplier information and the plurality of digital notifications, the supplier information being associated with the plurality of digital notifications. The set of operations include controlling the communication interface to receive a request for the plurality of digital notifications from a third-party server, the request including the supplier information and one or more remuneration vehicle identifiers that identify a portion of the plurality of remuneration vehicles. The set of operations include controlling the memory to retrieve a portion of the plurality of digital notifications from the memory based on the supplier information and the one or more remuneration vehicle identifiers. The set of operations also include controlling the communication interface to output the portion of the plurality of digital notifications to the third-party server. The portion of the plurality of digital notifications notify a user of the third-party server of a difference between the portion of the plurality of remuneration vehicles and other remuneration vehicles that are distinct from the portion of the plurality of remuneration vehicles

Other aspects of the embodiments will become apparent by consideration of the detailed description and accompanying drawings.

### BRIEF DESCRIPTION OF THE DRAWINGS

FIG. 1 is a block diagram illustrating a digital notification system, in accordance with various aspects of the present disclosure.

FIG. 2 is a flow diagram illustrating a process for communicating a digital notification from the server to the vehicle holder device with the third-party server of FIG. 1, in accordance with various aspects of the present disclosure.

FIGS. 3-6 are images illustrating a communication of a digital notification from the server to the vehicle holder device with the third-party server of FIG. 1, in accordance with various aspects of the present disclosure.

FIG. 7 is a flowchart illustrating an example method performed by the digital notification system of FIG. 1, in accordance with various aspects of the present disclosure.

### DETAILED DESCRIPTION OF EXEMPLARY EMBODIMENTS

Before any embodiments of the present disclosure are explained in detail, it is to be understood that the present disclosure is not limited in its application to the details of construction and the arrangement of components set forth in the following description or illustrated in the following drawings. The present disclosure is capable of other embodiments and of being practiced or of being carried out in various ways.

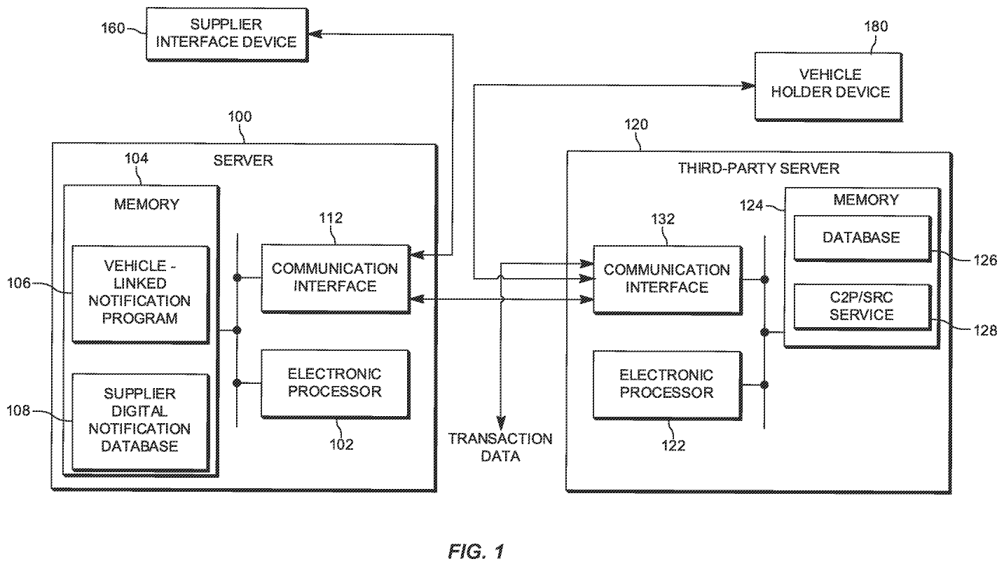

FIG. 1 is a block diagram illustrating a digital notification system, in accordance with various aspects of the present disclosure. It should be understood that, in some embodiments, there are different configurations from the configuration illustrated in FIG. 1. The functionality described herein may be extended to any number of servers providing distributed processing.

In the example of FIG. 1, the digital notification system 10 includes a server 100, a third-party server 120, a supplier interface device 160 (hereinafter referred to as “merchant interface device 160”), and a vehicle holder interface device 180 (hereinafter referred to as “cardholder interface device 180”). In some examples, the merchant interface device 160 may be a personal desktop computer, a laptop computer, a tablet computer, a personal digital assistant, a mobile phone, or other suitable computing device. Similarly, in some examples, the cardholder interface device 180 may be a personal desktop computer, a laptop computer, a tablet computer, a personal digital assistant, a mobile phone, or other suitable computing device.

The server 100 includes an electronic processor 102 (for example, a microprocessor or another suitable processing device), a memory 104 (for example, a non-transitory computer-readable storage medium), and a communication interface 112. It should be understood that, in some embodiments, the server 100 may include fewer or additional components in configurations different from that illustrated in FIG. 1. Also, the server 100 may perform additional functionality than the functionality described herein. In addition, the functionality of the server 100 may be incorporated into other servers. As illustrated in FIG. 1, the electronic processor 102, the memory 104, and the communication interface 112 are electrically coupled by one or more control or data buses enabling communication between the components.

The electronic processor 102 executes machine-readable instructions stored in the memory 104. For example, the electronic processor 102 may execute instructions stored in the memory 104 to perform the functionality described herein.

The memory 104 may include a program storage area (for example, read only memory (ROM)) and a data storage area (for example, random access memory (RAM), and other non-transitory, machine-readable medium). In some examples, the program storage area may store the instructions regarding a vehicle-linked notification program. In some examples, the data storage area may include a database, for example, a supplier digital notification database 108 that stores supplier information and a plurality of digital notifications from the supplier interface device 160. The plurality of digital notifications being associated with the supplier information.

The vehicle-linked notification service 106 has machine-readable instructions that, when executed by the electronic processor 102, cause the electronic processor 102 to perform a set of operations. The set of operations includes receiving supplier information and a plurality of digital notifications from the supplier interface device 160. Each of the plurality of digital notifications linked to one or more remuneration vehicles of a plurality of remuneration vehicles and the supplier information. The set of operations includes storing the supplier information and the plurality of digital notifications in the memory 104 (for example, storing the supplier information and the plurality of digital notifications in the supplier digital notification database 108). The supplier information is associated with the plurality of digital notifications. The set of operations includes receiving a request for the plurality of digital notifications from the third-party server. The request includes the supplier information and one or more remuneration vehicle identifiers that identify a portion of the plurality of remuneration vehicles. The set of operations includes retrieve a portion of the plurality of digital notifications from the memory based on the supplier information and the one or more remuneration vehicle identifiers. The set of operations also includes output the portion of the plurality of digital notifications to the third-party server. The portion of the plurality of digital notifications notify a user of the third-party server of a difference between the portion of the plurality of remuneration vehicles and other remuneration vehicles that are distinct from the portion of the plurality of remuneration vehicles.

The communication interface 112 receives data from and provides data to devices external to the server 100, such as the third-party server 120 and the merchant interface device 160. For example, the communication interface 112 may include a port or connection for receiving a wired connection (for example, an Ethernet cable, fiber optic cable, a telephone cable, or the like), a wireless transceiver, or a combination thereof. In some examples, the communication interface 112 may communicate with one or more of the third-party server 120 and the merchant interface device 160 via the internet.

In the example of FIG. 1, the third-party server 120 includes an electronic processor 122 (for example, a microprocessor or another suitable processing device), a memory 124 (for example, a non-transitory computer-readable storage medium), and a communication interface 132. It should be understood that, in some embodiments, the third-party server 120 may include fewer or additional components in configurations different from that illustrated in FIG. 1. Also, the third-party server 120 may perform additional functionality than the functionality described herein. In addition, the functionality of the third-party server 120 may be incorporated into other servers (e.g., incorporated into the server 100). As illustrated in FIG. 1, the electronic processor 122, the memory 124, and the communication interface 132 are electrically coupled by one or more control or data buses enabling communication between the components.

The electronic processor 122 executes machine-readable instructions stored in the memory 124. For example, the electronic processor 122 may execute instructions stored in the memory 124 to perform the functionality described herein.

The memory 124 may include a program storage area (for example, read only memory (ROM)) and a data storage area (for example, random access memory (RAM), and other non-transitory, machine-readable medium). The data storage area includes a database 126 and a click-to-pay/secure remote checkout (C2P/SRC) service 128.

The database 126 stores, among other things, a plurality of digital notifications for notifying users of the third-party server 120. The C2P/SRC service 128 provides a simplified digital checkout function for the vehicle holder device 180 from a supplier.

The communication interface 132 receives data from and provides data to devices external to the third-party server 120, i.e., the server 100, the vehicle holder device 160, and a payment processing server (not shown). For example, the communication interface 132 may include a port or connection for receiving a wired connection (for example, an Ethernet cable, fiber optic cable, a telephone cable, or the like), a wireless transceiver, or a combination thereof. In some examples, the communication interface 132 may be communicatively connected to the communication interface 112 via the Internet. In some examples, the communication interface 132 may provide transaction data to a payment processing server (not shown).

In some examples, the server 100 includes one or more user interfaces (not shown). The one or more user interfaces include one or more input mechanisms (for example, a touch screen, a keypad, a button, a knob, and the like), one or more output mechanisms (for example, a display, a printer, a speaker, and the like), or a combination thereof. The one or more optional user interfaces receive input from a user, provide output to a user, or a combination thereof. In some embodiments, as an alternative to or in addition to managing inputs and outputs through the one or more optional user interfaces, the server 100 may receive user input, provide user output, or both by communicating with an external device (e.g., the merchant interface device 160 or a workstation (not shown)) over a wired or wireless connection.

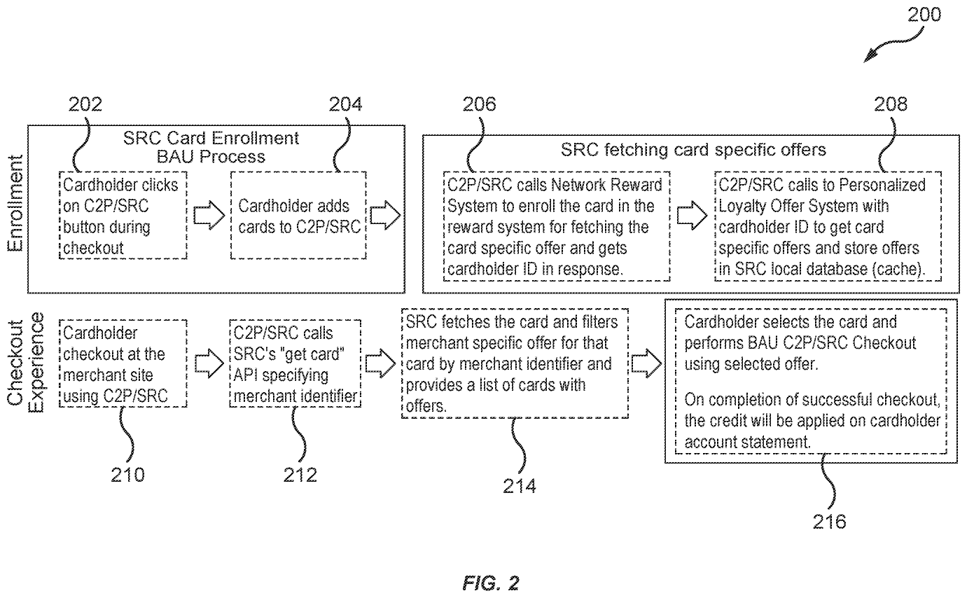

FIG. 2 is a flow diagram illustrating a process 200 for communicating a digital notification from the server 100 to the vehicle holder device 180 with the third-party server 120 of FIG. 1, in accordance with various aspects of the present disclosure. In the example of FIG. 2, the process 200 includes the server 100, the third-party server 120, the merchant interface device 160, and the cardholder interface device 180 of FIG. 1.

The third-party server 120 at the request of a remuneration vehicle holder (e.g., a cardholder) from the vehicle holder device 180 enrolls the remuneration vehicle holder with the vehicle-linked notification service 106 of the server 100. The server 100 responds with an enrollment confirmation to the third-party server 120, which relays the enrollment confirmation to the vehicle holder device 180.

The remuneration vehicle holder using the vehicle holder device 180 is presented with a C2P/SRC button during checkout on a webpage or smartphone application (at block 202). Unless previously added, the cardholder adds one or more remuneration vehicles (i.e., one or more payment cards) to the C2P/SRC hosted by the third-party server 120 (at block 204). The third-party server 120 calls a payment processor to get a remuneration vehicle holder identifier (ID) (at block 206). The third-party server 120 calls the server 100 to access the vehicle-linked notification service (also referred to as a personalized loyalty offer system) with the remuneration vehicle holder ID and the supplier information (at block 208). The server 100 returns a plurality of digital notifications to the third-party server 120 and the third-party server 120 stores the plurality of digital notifications in a local database (e.g., database 126) (at block 208).

The vehicle holder device 180 detects its location using cell tower locations, GPS coordinates, or other suitable location service. Assuming the remuneration vehicle holder has already added remuneration vehicles, as illustrated in FIG. 2, the remuneration vehicle holder using the vehicle holder device 180 is presented a C2P/SRC button during checkout on a webpage or smartphone application based on the detected location (at block 210). The third-party server 120 with the C2P/SRC service 128 calls a “get remuneration vehicle” API (e.g., a “get payment card” API) specifying a supplier identifier located at the detected location (at block 212). The third-party server 120 with the C2P/SRC service 128 filters the remuneration vehicle and supplier specific digital notification for that remuneration vehicle and provides a list of remuneration vehicles, each remuneration vehicle with zero or more digital notifications from the supplier, where at least one from the list of remuneration vehicles has one or more digital notifications from the supplier (at block 214). The third-party server 120 receives a selected remuneration vehicle from the list via the vehicle holder device 180 and performs a checkout function based on the selected remuneration vehicle (at block 216).

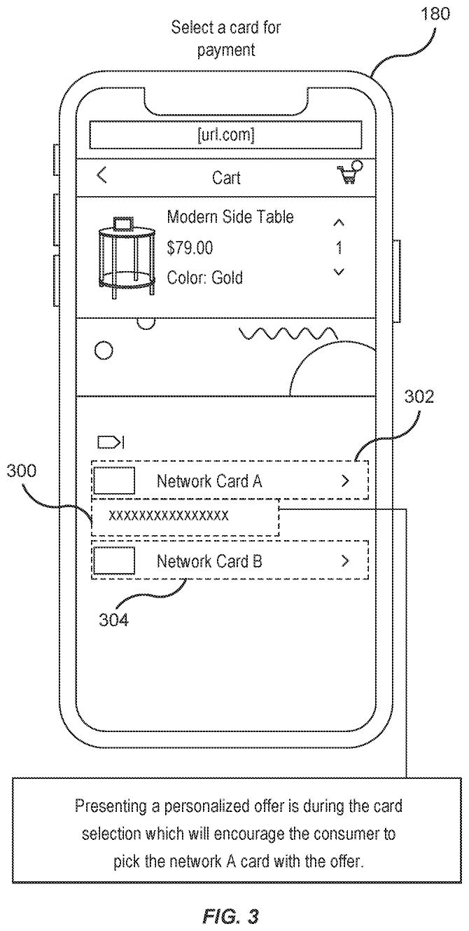

FIGS. 3-6 are images illustrating a communication of a digital notification 300 from the server 100 to the vehicle holder device 180 with the third-party server 120 of FIG. 1, in accordance with various aspects of the present disclosure. In the example of FIGS. 3-6, the digital notification system 300 includes the server 100, the third-party server 120, the merchant interface device 160, and the cardholder interface device 180.

As illustrated in FIG. 3, the vehicle holder device 180 is a smartphone with a presence-sensitive display. The presence-sensitive display displays a graphical user interface with the digital notification 300 associated with a first remuneration vehicle 302. The digital notification 300 is from the server 100 via the third-party server 120. In some examples, the digital notification is a personalized offer that is presented to a user of the vehicle holder device 180 during a remuneration vehicle selection process just prior to a checkout process. The second remuneration vehicle 304 is not associated with any digital notification.

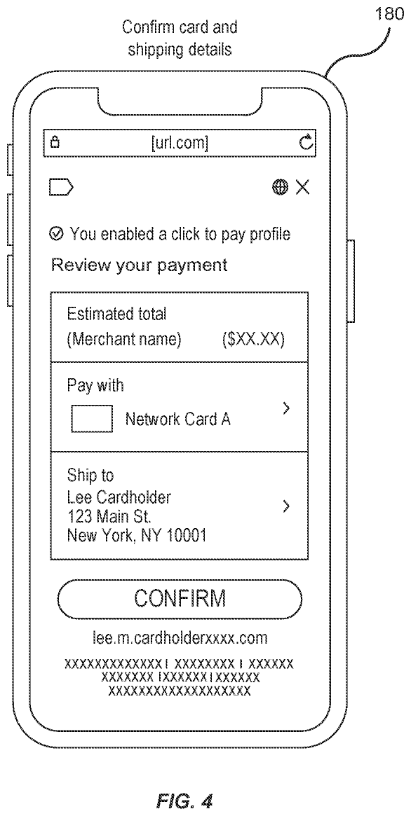

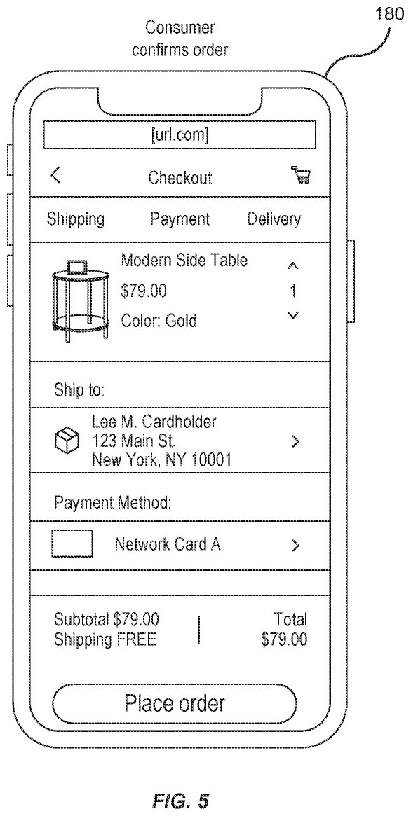

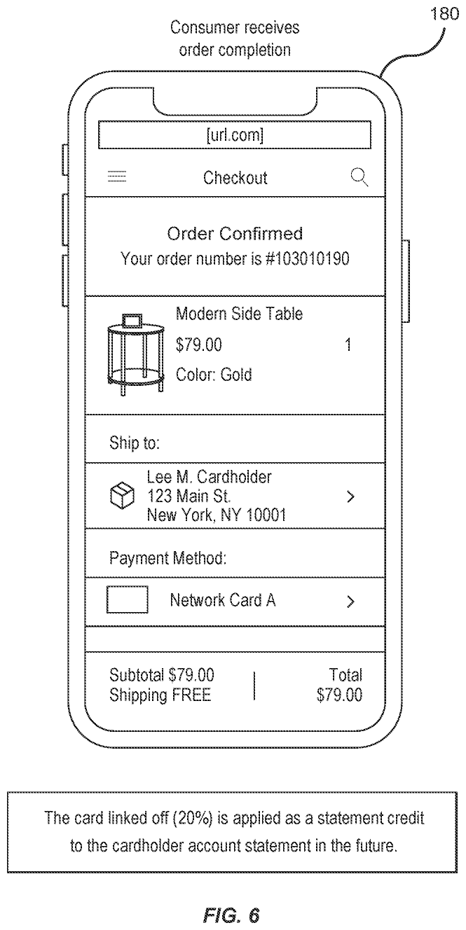

As illustrated in FIG. 4, the presence-sensitive display displays a second graphical user of a payment review page after the user of the vehicle holder device 180 selects the first remuneration vehicle 302 during the remuneration vehicle selection process. As illustrated in FIG. 5, the presence-sensitive display displays a third graphical user of a place order page after the user of the vehicle holder device 180 reviews the payment review page. As illustrated in FIG. 6, the presence-sensitive display displays a fourth graphical user of an order confirmation page after the user of the vehicle holder device 180 places the order.

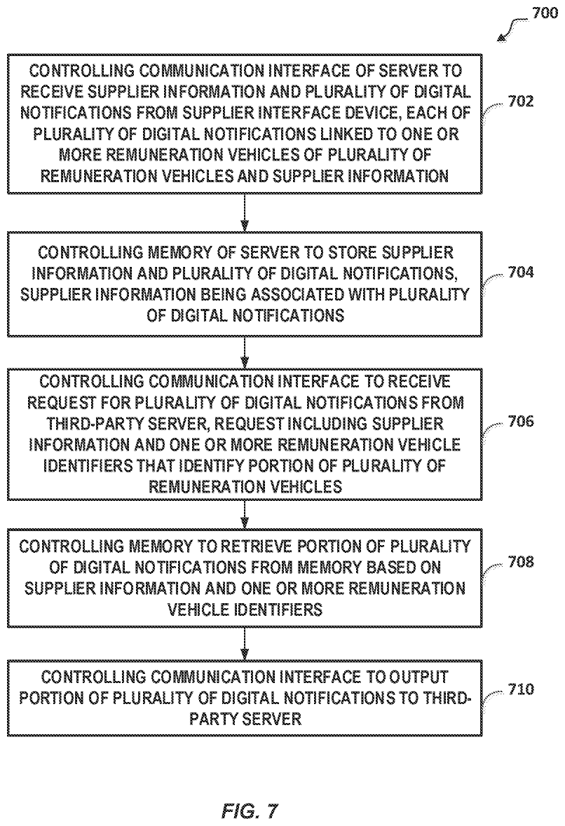

FIG. 7 is a flowchart illustrating an example method 700 performed by the digital notification system 10 of FIG. 1, in accordance with various aspects of the present disclosure. FIG. 7 is performed by the server 100 of FIG.

In the example of FIG. 7, the method 700 includes controlling, with the electronic processor 102 of the server 100, the communication interface 112 of the server 100 to receive supplier information and a plurality of digital notifications from the supplier interface device 160, each of the plurality of digital notifications linked to one or more remuneration vehicles of a plurality of remuneration vehicles and the supplier information (at block 702).

The method 700 includes controlling, with the electronic processor 102, the memory 104 of the server 100 to store the supplier information and the plurality of digital notifications, the supplier information being associated with the plurality of digital notifications (at block 704).

The method 700 includes controlling, with the electronic processor 102, the communication interface 112 to receive a request for the plurality of digital notifications from the third-party server 120, the request including the supplier information and one or more remuneration vehicle identifiers that identify a portion of the plurality of remuneration vehicles (at block 706).

The method 700 includes controlling, with the electronic processor 102, the memory 104 to retrieve a portion of the plurality of digital notifications from the memory 104 based on the supplier information and the one or more remuneration vehicle identifiers (at block 708).

The method 700 also includes controlling, with the electronic processor 102, the communication interface 112 to output the portion of the plurality of digital notifications to the third-party server 120 (at block 710). The portion of the plurality of digital notifications notify a user of the third-party server 120 of a difference between the portion of the plurality of remuneration vehicles and other remuneration vehicles that are distinct from the portion of the plurality of remuneration vehicles.

In some examples, the method 700 may further include controlling the communication interface to receive second supplier information and a second plurality of digital notifications from a second supplier interface device, each of the second plurality of digital notifications linked to a second one or more remuneration vehicles of the plurality of remuneration vehicles and the second supplier information. In some examples, the method 700 may further include controlling the memory to store the second supplier information and the second plurality of digital notifications in the memory, the second supplier information being associated with the second plurality of digital notifications. In some examples, the method 700 may further include controlling the communication interface to receive a second request for the second plurality of digital notifications from the third-party server, the second request including the second supplier information and a second one or more remuneration vehicle identifiers that identify a second portion of the plurality of remuneration vehicles. In some examples, the method 700 may further include controlling the memory to retrieve a portion of the second plurality of digital notifications from the memory based on the second supplier information and the second one or more remuneration vehicle identifiers. In some examples, the method 700 may also include controlling the communication interface to output the portion of the second plurality of digital notifications to the third-party server. In these examples, the portion of the second plurality of digital notifications notifies a second user of the third-party server of a difference between the second portion of the plurality of remuneration vehicles and second other remuneration vehicles that are distinct from the second portion of the plurality of remuneration vehicles.

In some examples, the plurality of digital notifications is associated with a first supplier and one or more locations of the first supplier, and wherein the second plurality of digital notifications is associated with a second supplier and one or more locations of the second supplier.

In some examples, the method 700 may further include controlling the communication interface to receive an enrollment request by a vehicle holder device to enroll in a vehicle-linked notification service, controlling the memory to store a first remuneration vehicle associated with the vehicle holder device in the plurality of remuneration vehicles, and controlling the communication interface to send an enrollment confirmation that confirms enrollment of the first remuneration vehicle in the vehicle-linked notification service. In these examples, the enrollment request is received from the third-party server, and the enrollment confirmation is sent to the third-party server. Alternatively, in other examples, the enrollment request is received from the vehicle holder device, and the enrollment confirmation is sent to the vehicle holder device. Additionally, in these above examples, the difference between the portion of the plurality of remuneration vehicles and the other remuneration vehicles that are distinct from the portion of the plurality of remuneration vehicles is a personalized offer that is presented to a user of the vehicle holder device during a remuneration vehicle selection process just prior to a checkout process.

The following are enumerated examples of digital notification servers, methods, and non-transitory computer-readable media as described herein. Example 1: a server comprising: a communication interface configured to: communicate with a supplier interface device, and communicate with a third-party server; a memory storing a vehicle-linked notification service; and an electronic processor communicatively connected to the memory, the electronic processor configured to receive supplier information and a plurality of digital notifications from the supplier interface device, each of the plurality of digital notifications linked to one or more remuneration vehicles of a plurality of remuneration vehicles and the supplier information, store the supplier information and the plurality of digital notifications in the memory, the supplier information being associated with the plurality of digital notifications, receive a request for the plurality of digital notifications from the third-party server, the request including the supplier information and one or more remuneration vehicle identifiers that identify a portion of the plurality of remuneration vehicles, retrieve a portion of the plurality of digital notifications from the memory based on the supplier information and the one or more remuneration vehicle identifiers, and output the portion of the plurality of digital notifications to the third-party server, wherein the portion of the plurality of digital notifications notify a user of the third-party server of a difference between the portion of the plurality of remuneration vehicles and other remuneration vehicles that are distinct from the portion of the plurality of remuneration vehicles.

Example 2: the server of Example 1, wherein the communication interface is further configured to communicate with a second supplier interface device, and wherein the electronic processor is further configured to receive second supplier information and a second plurality of digital notifications from the second supplier interface device, each of the second plurality of digital notifications linked to a second one or more remuneration vehicles of the plurality of remuneration vehicles and the second supplier information, store the second supplier information and the second plurality of digital notifications in the memory, the second supplier information being associated with the second plurality of digital notifications, receive a second request for the second plurality of digital notifications from the third-party server, the second request including the second supplier information and a second one or more remuneration vehicle identifiers that identify a second portion of the plurality of remuneration vehicles, retrieve a portion of the second plurality of digital notifications from the memory based on the second supplier information and the second one or more remuneration vehicle identifiers, and output the portion of the second plurality of digital notifications to the third-party server, wherein the portion of the second plurality of digital notifications notify a second user of the third-party server of a difference between the second portion of the plurality of remuneration vehicles and second other remuneration vehicles that are distinct from the second portion of the plurality of remuneration vehicles.

Example 3: the server of Example 2, wherein the plurality of digital notifications is associated with a first supplier and one or more locations of the first supplier, and wherein the second plurality of digital notifications is associated with a second supplier and one or more locations of the second supplier.

Example 4: the server of any of Examples 1-3, wherein the electronic processor is further configured to receive an enrollment request by a vehicle holder device to enroll in a vehicle-linked notification service, store a first remuneration vehicle associated with the vehicle holder device in the plurality of remuneration vehicles, and send an enrollment confirmation that confirms enrollment of the first remuneration vehicle in the vehicle-linked notification service.

Example 5: the server of Example 4, wherein the enrollment request is received from the third-party server, and wherein the enrollment confirmation is sent to the third-party server.

Example 6: the server of Example 4, wherein the enrollment request is received from the vehicle holder device, and wherein the enrollment confirmation is sent to the vehicle holder device.

Example 7: the server of Example 4, wherein the difference between the portion of the plurality of remuneration vehicles and the other remuneration vehicles that are distinct from the portion of the plurality of remuneration vehicles is a personalized offer that is presented to a user of the vehicle holder device during a remuneration vehicle selection process just prior to a checkout process.

Example 8: a method comprising: controlling, with an electronic processor of a server, a communication interface of the server to receive supplier information and a plurality of digital notifications from a supplier interface device, each of the plurality of digital notifications linked to one or more remuneration vehicles of a plurality of remuneration vehicles and the supplier information; controlling, with the electronic processor, a memory of the server to store the supplier information and the plurality of digital notifications, the supplier information being associated with the plurality of digital notifications; controlling, with the electronic processor, the communication interface to receive a request for the plurality of digital notifications from a third-party server, the request including the supplier information and one or more remuneration vehicle identifiers that identify a portion of the plurality of remuneration vehicles; controlling, with the electronic processor, the memory to retrieve a portion of the plurality of digital notifications from the memory based on the supplier information and the one or more remuneration vehicle identifiers; and controlling, with the electronic processor, the communication interface to output the portion of the plurality of digital notifications to the third-party server, wherein the portion of the plurality of digital notifications notify a user of the third-party server of a difference between the portion of the plurality of remuneration vehicles and other remuneration vehicles that are distinct from the portion of the plurality of remuneration vehicles.

Example 9: the method of Example 8, further comprising: controlling the communication interface to receive second supplier information and a second plurality of digital notifications from a second supplier interface device, each of the second plurality of digital notifications linked to a second one or more remuneration vehicles of the plurality of remuneration vehicles and the second supplier information; controlling the memory to store the second supplier information and the second plurality of digital notifications in the memory, the second supplier information being associated with the second plurality of digital notifications; controlling the communication interface to receive a second request for the second plurality of digital notifications from the third-party server, the second request including the second supplier information and a second one or more remuneration vehicle identifiers that identify a second portion of the plurality of remuneration vehicles; controlling the memory to retrieve a portion of the second plurality of digital notifications from the memory based on the second supplier information and the second one or more remuneration vehicle identifiers; and controlling the communication interface to output the portion of the second plurality of digital notifications to the third-party server, wherein the portion of the second plurality of digital notifications notify a second user of the third-party server of a difference between the second portion of the plurality of remuneration vehicles and second other remuneration vehicles that are distinct from the second portion of the plurality of remuneration vehicles.

Example 10: the method of Example 9, wherein the plurality of digital notifications is associated with a first supplier and one or more locations of the first supplier, and wherein the second plurality of digital notifications is associated with a second supplier and one or more locations of the second supplier.

Example 11: the method of any of Examples 8-10, further comprising: controlling the communication interface to receive an enrollment request by a vehicle holder device to enroll in a vehicle-linked notification service; controlling the memory to store a first remuneration vehicle associated with the vehicle holder device in the plurality of remuneration vehicles; and controlling the communication interface to send an enrollment confirmation that confirms enrollment of the first remuneration vehicle in the vehicle-linked notification service.

Example 12: the method of Example 11, wherein the enrollment request is received from the third-party server, and wherein the enrollment confirmation is sent to the third-party server.

Example 13: the method of Example 11, wherein the enrollment request is received from the vehicle holder device, and wherein the enrollment confirmation is sent to the vehicle holder device.

Example 14: the method of Example 11, wherein the difference between the portion of the plurality of remuneration vehicles and the other remuneration vehicles that are distinct from the portion of the plurality of remuneration vehicles is a personalized offer that is presented to a user of the vehicle holder device during a remuneration vehicle selection process just prior to a checkout process.

Example 15: a non-transitory computer-readable medium comprising instructions that, when executed by an electronic processor, cause the electronic processor to perform a set of operations comprising: controlling a communication interface of a server to receive supplier information and a plurality of digital notifications from a supplier interface device, each of the plurality of digital notifications linked to one or more remuneration vehicles of a plurality of remuneration vehicles and the supplier information; controlling a memory of the server to store the supplier information and the plurality of digital notifications, the supplier information being associated with the plurality of digital notifications; controlling the communication interface to receive a request for the plurality of digital notifications from a third-party server, the request including the supplier information and one or more remuneration vehicle identifiers that identify a portion of the plurality of remuneration vehicles; controlling the memory to retrieve a portion of the plurality of digital notifications from the memory based on the supplier information and the one or more remuneration vehicle identifiers; and controlling the communication interface to output the portion of the plurality of digital notifications to the third-party server, wherein the portion of the plurality of digital notifications notify a user of the third-party server of a difference between the portion of the plurality of remuneration vehicles and other remuneration vehicles that are distinct from the portion of the plurality of remuneration vehicles.

Example 16: the non-transitory computer-readable medium of Example 15, wherein the set of operations further includes receiving second supplier information and a second plurality of digital notifications from a second supplier interface device, each of the second plurality of digital notifications linked to a second one or more remuneration vehicles of the plurality of remuneration vehicles and the second supplier information; storing the second supplier information and the second plurality of digital notifications in the memory, the second supplier information being associated with the second plurality of digital notifications; receiving a second request for the second plurality of digital notifications from the third-party server, the second request including the second supplier information and a second one or more remuneration vehicle identifiers that identify a second portion of the plurality of remuneration vehicles; retrieving a portion of the second plurality of digital notifications from the memory based on the second supplier information and the second one or more remuneration vehicle identifiers; and outputting the portion of the second plurality of digital notifications to the third-party server, wherein the portion of the second plurality of digital notifications notify a second user of the third-party server of a difference between the second portion of the plurality of remuneration vehicles and second other remuneration vehicles that are distinct from the second portion of the plurality of remuneration vehicles.

Example 17: the non-transitory computer-readable medium of Example 16, wherein the plurality of digital notifications is associated with a first supplier and one or more locations of the first supplier, and wherein the second plurality of digital notifications is associated with a second supplier and one or more locations of the second supplier.

Example 18: the non-transitory computer-readable medium of any of Examples 15-17, wherein the set of operations further includes receiving an enrollment request by a vehicle holder device to enroll in a vehicle-linked notification service; storing a first remuneration vehicle associated with the vehicle holder device in the plurality of remuneration vehicles; and sending an enrollment confirmation that confirms enrollment of the first remuneration vehicle in the vehicle-linked notification service.

Example 19: the non-transitory computer-readable medium of Example 18, wherein the enrollment request is received from the third-party server, and wherein the enrollment confirmation is sent to the third-party server.

Example 20: the non-transitory computer-readable medium of Example 18, wherein the enrollment request is received from the vehicle holder device, and wherein the enrollment confirmation is sent to the vehicle holder device.

The foregoing description is merely illustrative in nature and does not limit the scope of the disclosure or its applications. The broad teachings of the disclosure may be implemented in many different ways. While the disclosure includes some particular examples, other modifications will become apparent upon a study of the drawings, the text of this specification, and the following claims. In the written description and the claims, one or more processes within any given method may be executed in a different order—or processes may be executed concurrently or in combination with each other-without altering the principles of this disclosure. Similarly, instructions stored in a non-transitory computer-readable medium may be executed in a different order—or concurrently-without altering the principles of this disclosure. Unless otherwise indicated, the numbering or other labeling of instructions or method steps is done for convenient reference and does not necessarily indicate a fixed sequencing or ordering.

Unless the context of their usage unambiguously indicates otherwise, the articles “a,” “an,” and “the” should not be interpreted to mean “only one.” Rather, these articles should be interpreted to mean “at least one” or “one or more.” Likewise, when the terms “the” or “said” are used to refer to a noun previously introduced by the indefinite article “a” or “an,” the terms “the” or “said” should similarly be interpreted to mean “at least one” or “one or more” unless the context of their usage unambiguously indicates otherwise.

Spatial and functional relationships between elements-such as modules—are described using terms such as (but not limited to) “connected,” “engaged,” “interfaced,” and/or “coupled.” Unless explicitly described as being “direct,” relationships between elements may be direct or include intervening elements. The phrase “at least one of A, B, and C” should be construed to indicate a logical relationship (A OR B OR C), where OR is a non-exclusive logical OR, and should not be construed to mean “at least one of A, at least one of B, and at least one of C.” The term “set” does not necessarily exclude the empty set. For example, the term “set” may have zero elements. The term “subset” does not necessarily require a proper subset. For example, a “subset” of set A may be coextensive with set A, or include elements of set A. Furthermore, the term “subset” does not necessarily exclude the empty set.

In the figures, the directions of arrows generally demonstrate the flow of information—such as data or instructions. The direction of an arrow does not imply that information is not being transmitted in the reverse direction. For example, when information is sent from a first element to a second element, the arrow may point from the first element to the second element. However, the second element may send requests for data to the first element, and/or acknowledgements of receipt of information to the first element. Furthermore, while the figures illustrate a number of components and/or steps, any one or more of the components and/or steps may be omitted or duplicated, as suitable for the application and setting.

The term “computer-readable medium” does not encompass transitory electrical or electromagnetic signals or electromagnetic signals propagating through a medium-such as on an electromagnetic carrier wave. The term “computer-readable medium” is considered tangible and non-transitory. The functional blocks, flowchart elements, and message sequence charts described above serve as software specifications that may be translated into computer programs by the routine work of a skilled technician or programmer.

It should also be understood that although certain drawings illustrate hardware and software as being located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device, or they may be distributed among different computing devices-such as computing devices interconnected by one or more networks or other communications systems.

In the claims, if an apparatus or system is claimed as including an electronic processor or other element configured in a certain manner, the claim or claimed element should be interpreted as meaning one or more electronic processors (or other element as appropriate). If the electronic processor (or other element) is described as being configured to make one or more determinations or one or execute one or more steps, the claim should be interpreted to mean that any combination of the one or more electronic processors (or any combination of the one or more other elements) may be configured to execute any combination of the one or more determinations (or one or more steps).

Thus, the present disclosure provides, among other things, digital notification servers, methods, and non-transitory computer-readable media. Various features and advantages of the invention are set forth in the following claims.

What is claimed is:

1. A server comprising:
a communication interface configured to:
communicate with a supplier interface device, and
communicate with a third-party server;
a memory storing a vehicle-linked notification service; and
an electronic processor communicatively connected to the memory, the electronic processor configured to
receive supplier information and a plurality of digital notifications from the supplier interface device, each of the plurality of digital notifications linked to one or more remuneration vehicles of a plurality of remuneration vehicles and the supplier information,
store the supplier information and the plurality of digital notifications in the memory, the supplier information being associated with the plurality of digital notifications,
receive a request for the plurality of digital notifications from the third-party server, the request including the supplier information and one or more remuneration vehicle identifiers that identify a portion of the plurality of remuneration vehicles,
retrieve a portion of the plurality of digital notifications from the memory based on the supplier information and the one or more remuneration vehicle identifiers, and
output the portion of the plurality of digital notifications to the third-party server,
wherein the portion of the plurality of digital notifications notify a user of the third-party server of a difference between the portion of the plurality of remuneration vehicles and other remuneration vehicles that are distinct from the portion of the plurality of remuneration vehicles.

2. The server of claim 1, wherein the communication interface is further configured to communicate with a second supplier interface device, and wherein the electronic processor is further configured to
receive second supplier information and a second plurality of digital notifications from the second supplier interface device, each of the second plurality of digital notifications linked to a second one or more remuneration vehicles of the plurality of remuneration vehicles and the second supplier information,
store the second supplier information and the second plurality of digital notifications in the memory, the second supplier information being associated with the second plurality of digital notifications,
receive a second request for the second plurality of digital notifications from the third-party server, the second request including the second supplier information and a second one or more remuneration vehicle identifiers that identify a second portion of the plurality of remuneration vehicles,
retrieve a portion of the second plurality of digital notifications from the memory based on the second supplier information and the second one or more remuneration vehicle identifiers, and
output the portion of the second plurality of digital notifications to the third-party server, wherein the portion of the second plurality of digital notifications notify a second user of the third-party server of a difference between the second portion of the plurality of remuneration vehicles and second other remuneration vehicles that are distinct from the second portion of the plurality of remuneration vehicles.

3. The server of claim 2, wherein the plurality of digital notifications is associated with a first supplier and one or more locations of the first supplier, and wherein the second plurality of digital notifications is associated with a second supplier and one or more locations of the second supplier.

4. The server of claim 1, wherein the electronic processor is further configured to
receive an enrollment request by a vehicle holder device to enroll in a vehicle-linked notification service,
store a first remuneration vehicle associated with the vehicle holder device in the plurality of remuneration vehicles, and
send an enrollment confirmation that confirms enrollment of the first remuneration vehicle in the vehicle-linked notification service.

5. The server of claim 4, wherein the enrollment request is received from the third-party server, and wherein the enrollment confirmation is sent to the third-party server.

6. The server of claim 4, wherein the enrollment request is received from the vehicle holder device, and wherein the enrollment confirmation is sent to the vehicle holder device.

7. The server of claim 4, wherein the difference between the portion of the plurality of remuneration vehicles and the other remuneration vehicles that are distinct from the portion of the plurality of remuneration vehicles is a personalized offer that is presented to a user of the vehicle holder device during a remuneration vehicle selection process just prior to a checkout process.

8. A method comprising:
controlling, with an electronic processor of a server, a communication interface of the server to receive supplier information and a plurality of digital notifications from a supplier interface device, each of the plurality of digital notifications linked to one or more remuneration vehicles of a plurality of remuneration vehicles and the supplier information;
controlling, with the electronic processor, a memory of the server to store the supplier information and the plurality of digital notifications, the supplier information being associated with the plurality of digital notifications;
controlling, with the electronic processor, the communication interface to receive a request for the plurality of digital notifications from a third-party server, the request including the supplier information and one or more remuneration vehicle identifiers that identify a portion of the plurality of remuneration vehicles;
controlling, with the electronic processor, the memory to retrieve a portion of the plurality of digital notifications from the memory based on the supplier information and the one or more remuneration vehicle identifiers; and
controlling, with the electronic processor, the communication interface to output the portion of the plurality of digital notifications to the third-party server,
wherein the portion of the plurality of digital notifications notify a user of the third-party server of a difference between the portion of the plurality of remuneration vehicles and other remuneration vehicles that are distinct from the portion of the plurality of remuneration vehicles.

9. The method of claim 8, further comprising:
controlling the communication interface to receive second supplier information and a second plurality of digital notifications from a second supplier interface device, each of the second plurality of digital notifications linked to a second one or more remuneration vehicles of the plurality of remuneration vehicles and the second supplier information;
controlling the memory to store the second supplier information and the second plurality of digital notifications in the memory, the second supplier information being associated with the second plurality of digital notifications;
controlling the communication interface to receive a second request for the second plurality of digital notifications from the third-party server, the second request including the second supplier information and a second one or more remuneration vehicle identifiers that identify a second portion of the plurality of remuneration vehicles;
controlling the memory to retrieve a portion of the second plurality of digital notifications from the memory based on the second supplier information and the second one or more remuneration vehicle identifiers; and
controlling the communication interface to output the portion of the second plurality of digital notifications to the third-party server,
wherein the portion of the second plurality of digital notifications notify a second user of the third-party server of a difference between the second portion of the plurality of remuneration vehicles and second other remuneration vehicles that are distinct from the second portion of the plurality of remuneration vehicles.

10. The method of claim 9, wherein the plurality of digital notifications is associated with a first supplier and one or more locations of the first supplier, and wherein the second plurality of digital notifications is associated with a second supplier and one or more locations of the second supplier.

11. The method of claim 8, further comprising:
controlling the communication interface to receive an enrollment request by a vehicle holder device to enroll in a vehicle-linked notification service;
controlling the memory to store a first remuneration vehicle associated with the vehicle holder device in the plurality of remuneration vehicles; and
controlling the communication interface to send an enrollment confirmation that confirms enrollment of the first remuneration vehicle in the vehicle-linked notification service.

12. The method of claim 11, wherein the enrollment request is received from the third-party server, and wherein the enrollment confirmation is sent to the third-party server.

13. The method of claim 11, wherein the enrollment request is received from the vehicle holder device, and wherein the enrollment confirmation is sent to the vehicle holder device.

14. The method of claim 11, wherein the difference between the portion of the plurality of remuneration vehicles and the other remuneration vehicles that are distinct from the portion of the plurality of remuneration vehicles is a personalized offer that is presented to a user of the vehicle holder device during a remuneration vehicle selection process just prior to a checkout process.

15. A non-transitory computer-readable medium comprising instructions that, when executed by an electronic processor, cause the electronic processor to perform a set of operations comprising:
controlling a communication interface of a server to receive supplier information and a plurality of digital notifications from a supplier interface device, each of the plurality of digital notifications linked to one or more remuneration vehicles of a plurality of remuneration vehicles and the supplier information;
controlling a memory of the server to store the supplier information and the plurality of digital notifications, the supplier information being associated with the plurality of digital notifications;
controlling the communication interface to receive a request for the plurality of digital notifications from a third-party server, the request including the supplier information and one or more remuneration vehicle identifiers that identify a portion of the plurality of remuneration vehicles;
controlling the memory to retrieve a portion of the plurality of digital notifications from the memory based on the supplier information and the one or more remuneration vehicle identifiers; and
controlling the communication interface to output the portion of the plurality of digital notifications to the third-party server,
wherein the portion of the plurality of digital notifications notify a user of the third-party server of a difference between the portion of the plurality of remuneration vehicles and other remuneration vehicles that are distinct from the portion of the plurality of remuneration vehicles.

16. The non-transitory computer-readable medium of claim 15, wherein the set of operations further includes
receiving second supplier information and a second plurality of digital notifications from a second supplier interface device, each of the second plurality of digital notifications linked to a second one or more remuneration vehicles of the plurality of remuneration vehicles and the second supplier information;
storing the second supplier information and the second plurality of digital notifications in the memory, the second supplier information being associated with the second plurality of digital notifications;
receiving a second request for the second plurality of digital notifications from the third-party server, the second request including the second supplier information and a second one or more remuneration vehicle identifiers that identify a second portion of the plurality of remuneration vehicles;
retrieving a portion of the second plurality of digital notifications from the memory based on the second supplier information and the second one or more remuneration vehicle identifiers; and
outputting the portion of the second plurality of digital notifications to the third-party server,
wherein the portion of the second plurality of digital notifications notify a second user of the third-party server of a difference between the second portion of the plurality of remuneration vehicles and second other remuneration vehicles that are distinct from the second portion of the plurality of remuneration vehicles.

17. The non-transitory computer-readable medium of claim 16, wherein the plurality of digital notifications is associated with a first supplier and one or more locations of the first supplier, and wherein the second plurality of digital notifications is associated with a second supplier and one or more locations of the second supplier.

18. The non-transitory computer-readable medium of claim 15, wherein the set of operations further includes
receiving an enrollment request by a vehicle holder device to enroll in a vehicle-linked notification service;
storing a first remuneration vehicle associated with the vehicle holder device in the plurality of remuneration vehicles; and
sending an enrollment confirmation that confirms enrollment of the first remuneration vehicle in the vehicle-linked notification service.

19. The non-transitory computer-readable medium of claim 18, wherein the enrollment request is received from the third-party server, and wherein the enrollment confirmation is sent to the third-party server.

20. The non-transitory computer-readable medium of claim 18, wherein the enrollment request is received from the vehicle holder device, and wherein the enrollment confirmation is sent to the vehicle holder device.
